(19) United States
(12) Patent Application Publication
(10) Pub. No.: US 2003/0189945 A1
(43) Pub. Date: Oct. 9, 2003

(54) Selective completion indication of controller events

(76) Inventors: Patrick L. Connor, Portland, OR (US); Daniel R. Gaur, Beaverton, OR (US)

Correspondence Address: PILLSBURY WINTHROP, LLP, P.O. BOX 10500, MCLEAN, VA, 22102, US

(21) Appl. No.: 10/115,930

(22) Filed: Apr. 5, 2002

(51) Int. Cl. H04L 12/28

(52) U.S. Cl. 370/419; 370/421

(57) ABSTRACT

An arrangement is provided for selective completion indication of controller events. Data to be transmitted is read and transmitted upon receiving a request for transmission. A completion indication assiciated with the status of the transmission is returned only when a request for the completion indication is received.

### BACKGROUND

Aspects of the present invention relate to communications. Other aspects of the present invention relate to packet transmission.

Throughput of a high-speed input output (I/O) controller is often limited by system bus. To perform an egress operation, there are conventionally a plurality of processing steps performed between a device driver and an I/O controller. This is illustrated in FIG. 1 (PRIOR ART), in which a conventional framework comprises an I/O controller 110, a host computer 120 hosting a device driver 130 connecting to the I/O controller 110 via a bus 140. To transmit data outbound, the device driver 130 writes, via the bus 140, to the I/O controller 110 first to inform the controller that new transmit descriptors are ready. This effectively serves as a request of transmission (150).

Upon receiving the request 150, the I/O controller 110 reads the packet descriptors 160 as well as the packet to be transmitted and subsequently sends the packet outbound. When the I/O controller 110 completes the transmission, it generates a completion indication 170 and sends it back to the device driver 130 to indicate that the transmission has been accomplished. The I/O controller 110 may indicate completion via an interrupt, special status bits, or other mechanisms.

Among the above described processing steps performed between the I/O controller 110 and the device driver 130, only one of the acts is related to the requested operation (e.g., transmit data outbound). Three out of four acts are bus activities for operational control. Hence, they are overhead. As a consequence, they reduce the bus efficiency and add unnecessary latency to the entire transaction.

### BRIEF DESCRIPTION OF THE DRAWINGS

The present invention is further described in terms of exemplary embodiments, which will be described in detail with reference to the drawings. These embodiments are non-limiting exemplary embodiments, in which like reference numerals represent similar parts throughout the several views of the drawings, and wherein:

FIG. 1 (Prior Art) illustrates a framework, in which, for each assigned task, a controller returns a completion indication to a device driver;

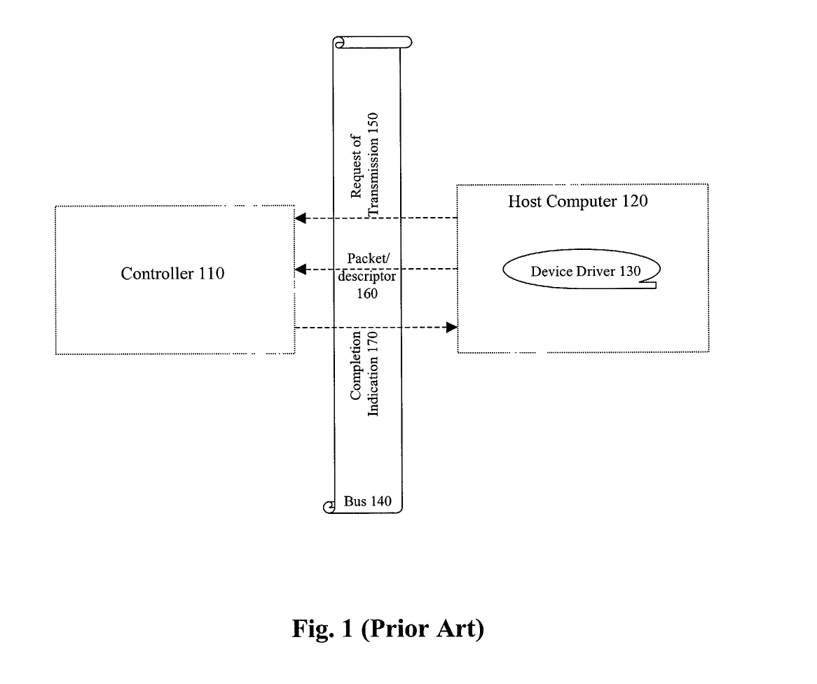

FIG. 2 depicts a framework, in which a controller returns a completion indication to a device driver only when a completion indication is requested at a request rate determined adaptively based on workload, according to embodiments of the present invention;

FIG. 3 depicts the internal structures of a workload based completion indication request mechanism and a request-initiated completion indication mechanism 220 as well as their relationship, according to embodiments of the present invention;

FIG. 4 is a flowchart of an exemplary process, in which a controller returns a completion indication to a device driver only when the completion indication is requested at a request rate determined adaptively based on workload, according to an embodiment of the present invention;

FIG. 5 is a flowchart of an exemplary process, in which a workload based completion indication request mechanism issues a completion indication request at a request rate determined adaptively based on workload, according to an embodiment of the present invention;

FIGS. 6(a) and (b) are flowcharts of exemplary processes, in which a completion indication request rate determiner adaptively updates a completion indication request rate based on dynamic workload information, according to different embodiments of the present invention; and

FIG. 7 is a flowchart of an exemplary process, in which a request initiated completion indication mechanism returns a completion indication associated with a task upon receiving a request for a completion indication, according to an embodiment of the present invention.

### DETAILED DESCRIPTION

The processing described below may be performed by a properly programmed general-purpose computer alone or in connection with a special purpose computer. Such processing may be performed by a single platform or by a distributed processing platform. In addition, such processing and functionality can be implemented in the form of special purpose hardware or in the form of software or firmware being run by a general-purpose or network processor. Any data handled in such processing or created as a result of such processing can be stored in any memory as is conventional in the art. By way of example, such data may be stored in a temporary memory, such as in the RAM of a given computer system or subsystem. In addition, or in the alternative, such data may be stored in longer-term storage devices, for example, magnetic disks, rewritable optical disks, and so on. For purposes of the disclosure herein, a computer-readable media may comprise any form of data storage mechanism, including such existing memory technologies as well as hardware or circuit representations of such structures and of such data.

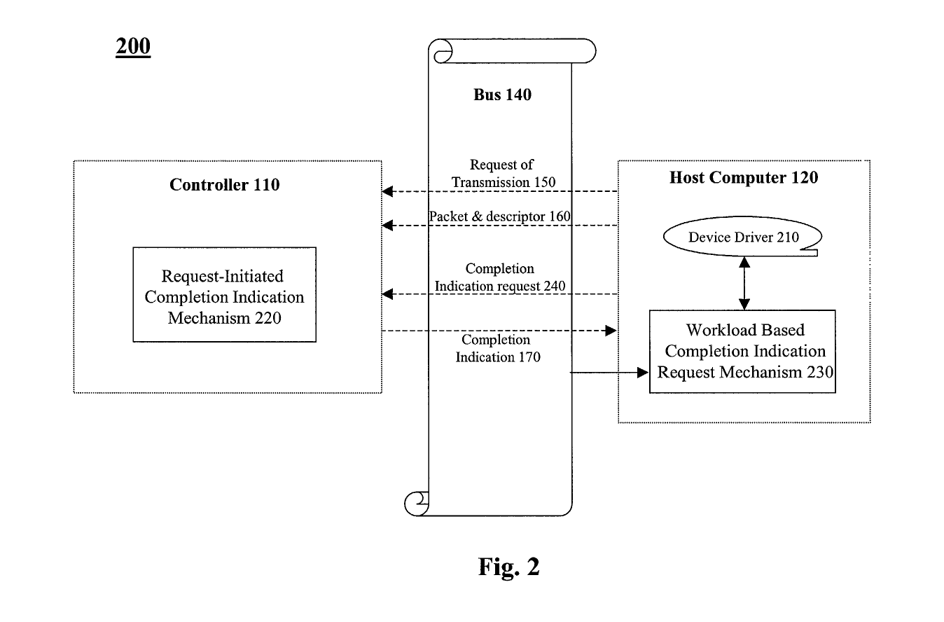

FIG. 2 depicts a framework 200, in which a controller 110 returns a completion indication 170 to a device driver 210 only when a completion indication is requested at a request rate determined adaptively based on workload, according to embodiments of the invention. The device driver 210 communicates with the controller 110 and assigns tasks to the controller 110 to perform. The controller 110 completes the tasks requested by the device driver 210. For example, the device driver 210 may request the controller to perform egress operations such as transmitting data outbound. To do so, the device driver 210 sends, via a bus 140, a request of transmission 150 to the controller 110 to transmit data outbound. At a dynamically determined rate, the device driver 210 may also request, through a completion indication request 240, the controller 110 to send back the completion indication 170 representing the performance status of a transmission.

The device driver 210 may reside on a host computer 120 and driven by a central unit processor (CPU) of the host computer 120 (not shown). The controller 110 may correspond to an input and output (I/O) controller such as Ethernet, small computer system interface (SCSI), and Infiniband™ Architecture, or a cryptography controller.

Upon receiving the request of transmission 150, the controller 110 reads, via the bus 140, information relevant to the requested transmission from the device driver 210. Such information may include a packet to be transmitted and associated descriptor (160). When the received packet is subsequently transmitted, a request-initiated completion indication mechanism 220 determines whether the device driver 210 sent a completion indication request 240 to demand a completion indication to be returned. If the completion indication request 240 has been received, the request-initiated completion indication mechanism 220 prepares a completion indication reflecting the status of the transmission and sends the completion indication 170 to the device driver 210.

To determine when to send the completion indication request 240, a workload based completion indication request mechanism 230 gathers information related to current workload and sends completion indication requests according to workload. The workload based completion indication request mechanism 230 may dynamically update a request rate which regulates how often to request a completion indication according to the workload with respect to different parts of the framework 200. For example, it may update the request rate based on the workload of the device driver 210. It may also base its update on the workload of the bus 140. Another possibility is to take into account the workload of the controller 110 based on returned completion indications. Furthermore, it may also consider the overall workload of the framework 200 in terms of a combined workload of the device driver 210, the bus 140, and the controller 110. In this case, workloads of different parts may be expressed as a vector.

The workload based completion indication request mechanism 230 facilitates the device driver 210 to adaptively request completion indication from the controller 110. It may be implemented as either part of the device driver 210 or it may be implemented separately. It, in cooperation with the device driver 210, forms a coherent facility enabling adaptive completion indication request mechanism.

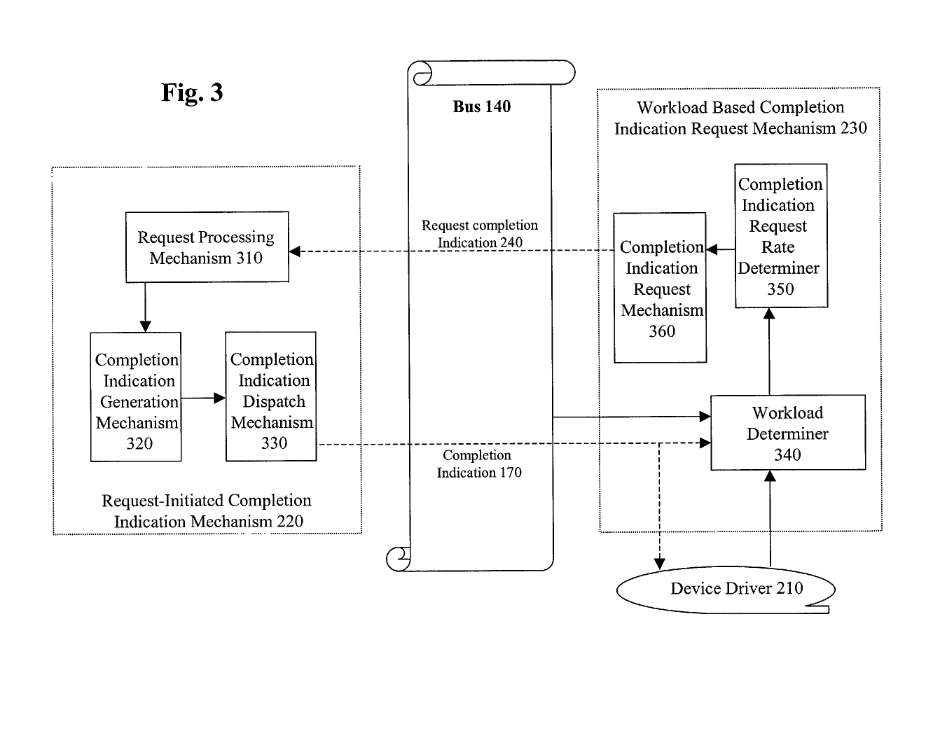

FIG. 3 depicts the internal structures of the workload based completion indication request mechanism 230 and the request-initiated completion indication mechanism 220 as well as their relationship, according to embodiments of the present invention. To dynamically send completion indication request at a rate adaptive to workload, the workload based completion indication request mechanism 230 comprises a workload determiner 340, a completion indication request rate determiner 350, and a completion indication request mechanism 360.

The workload determiner 340 may monitor the activities of different parts of the framework 200 and gather useful information to determine the workload. For example, it may monitor the device driver 210 to see how often it sends and receives data. It may also monitor the data traffic on the bus 140 to determine how busy the bus 140 is. It may also estimate the workload of the controller 110 based on returned completion indications. For instance, with a higher rate of failure in completing requested tasks, the controller 110 may be over loaded. Information so gathered is then used to estimate the relevant workload for the purpose of determining an adaptive request rate.

Workload may be measured in different ways. For example, workload of the bus 140 may be measured in terms of number of transactions conducted on the bus 140 in a unit time. It may also be measured as a utilization rate or usage percentage of the bus. In addition, the workload of the device driver 210 may also be measured in terms of number of packets or bytes transmitted in a unit time. Specific quantitative workload measures may also be converted into some qualitative evaluation of workload such as “busy” or “very busy”. Such qualitative workload evaluation may be achieved by classifying workload measures into several classes. One illustration is that each class may correspond to a range of quantitative measures. For instance, bus workload may be qualitatively characterized as “very busy” if its utilization percentage exceeds 75% or “not busy” if its utilization rate is below 30%.

Workloads of different parts of the framework 200 may be represented either separately or combined to produce an overall workload estimation. In some applications, it may be more useful to treat individual workload as separate. In other applications, it may be useful to derive an overall workload estimate.

It may be sometimes necessary to evaluate bottleneck based on detected workload measures. For example, if the utilization percentage of the bus 140 is reaching its limit, even though the device driver may still have extra bandwidth to handle more data, the overall workload may be evaluated as high so that potential overloading to the bus may be prevented. The workload determiner 340 may identify a bottleneck from individual workload measures of different parts or it may also assess in terms of an overall workload, if it is generated appropriately. Since the workload determiner 340 estimates workload based on dynamically gathered information, the estimated workload is adaptive to the changing environment.

The completion indication request rate determiner 350 adaptively computes a completion indication request rate based on the estimated workload (from the workload determiner 340). The computation may be achieved via different means. For example, a request rate may be computed using a formula. It is also possible to encode the relationship between various workload levels and request rates in the form of a table so that online computation can be achieved via a table look up operation.

Such a derived request rate is used to govern when and how often the controller 110 will be requested to return a completion indication upon finishing an assigned task. The request rate may be represented in different ways. It may be represented as a frequency specifying the number of requests to be sent within a unit time (e.g., send 5 completion indication requests every second.). It may also specify a rate in terms of periodicity corresponding to an interval between two consecutive completion indication requests. For example, a request rate may specify to send a completion indication request every 50 milliseconds. Alternatively, a request rate may specify to send a completion indication request every ten outbound operations.

Governed by a completion indication request rate, the completion indication request mechanism 360 sends completion indication requests to the controller 110. A request may be sent at the same time when the device driver 210 requests the controller 110 to transmit a packet. It may also be sent independent of a data transmission request. In this case, the completion indication request mechanism 360 may issue a completion indication request with a null (or no operation) command to demand the controller 110 to return a completion indication.

To facilitate completion indication issuance based on demand, the request-initiated completion indication mechanism 220 comprises a request processing mechanism 310, a completion indication generation mechanism 320, and a completion indication dispatch mechanism 330. Upon receiving a request for a completion indication, the request processing mechanism 310 processes the request and may determine the task with which the requested completion indication is associated. Based on the associated task, the completion indication generation mechanism 320 accordingly generates an appropriate completion indication. The generated completion indication may provide the information related to whether the controller 110 has successfully carried out the assigned task. Subsequently, the completion indication dispatch mechanism 330 sends the completion indication 170 to the device driver 210.

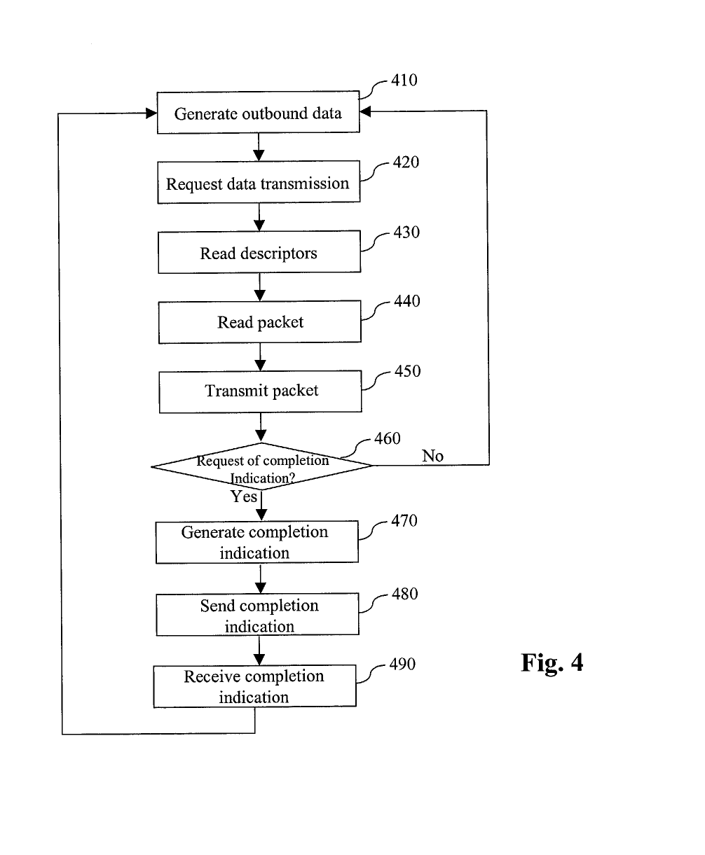

FIG. 4 is a flowchart of an exemplary process, in which the controller 110 returns a completion indication to the device driver 210 only when the completion indication is requested. The device driver 210 first generates, at 410, data to be transmitted. The device driver 210 then sends a request of transmission, at 420, to the controller 110. This effectively assigns a transmission task to the controller 110 (to transmit the data outbound).

Upon receiving the request of transmission 150 from the device driver 210, the controller 110 reads the packet to be transmitted and its descriptor from the device driver 210 at 430 and 440. The packet is then transmitted at 450. To determine whether a completion indication needs to be returned, it is first determined, at 460, whether a completion indication request has been received. If no completion indication request is received, the operation returns back to 410.

If a completion indication request is received, the completion indication generation mechanism 320 generates, at 470, a completion indication according to the performance status of the controller 110. The generated completion indication is then sent, at 480, to the device driver 210 via the bus 140. Subsequently, the device driver 210 receives, at 490, the completion indication.

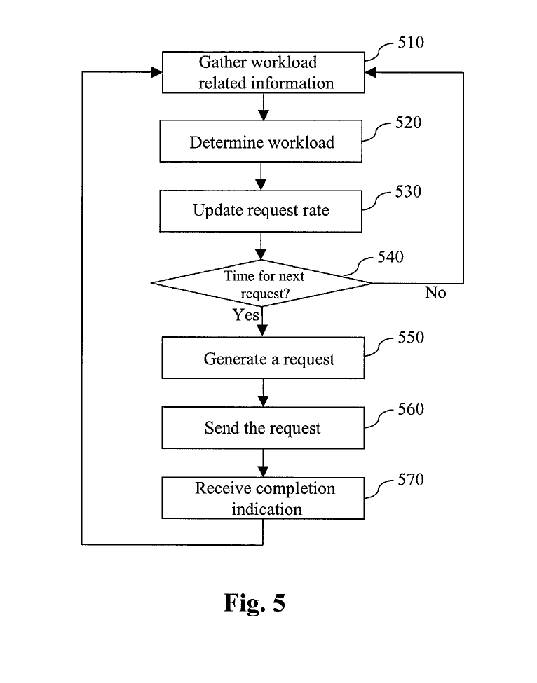

FIG. 5 is a flowchart of an exemplary process, in which the workload based completion indication request mechanism 230 issues a completion indication request at a request rate determined adaptively based on workload. Information relevant to workload is first gathered at 510. Utilizing such information, the workload determiner 340 determines, at 520, the dynamic workload, which is then used, by the completion indication request rate determiner 350, to update, at 530, a completion indication request rate. This produces an updated completion indication request rate. Based on the updated completion indication request rate, the completion indication request mechanism 360 determines, at 540, when to send next completion indication request.

When it is appropriate to send a completion indication request, the completion indication request mechanism 360 generates, at 550, a completion indication request and sends, at 560, the request to the controller 110. When the requested completion indication is returned to the device driver 210, the completion indication request rate determiner 350 may intercept or receive, at 570, the completion indication. The received completion indication may be later used as a source of information in determining how the current completion indication request rate is to be updated.

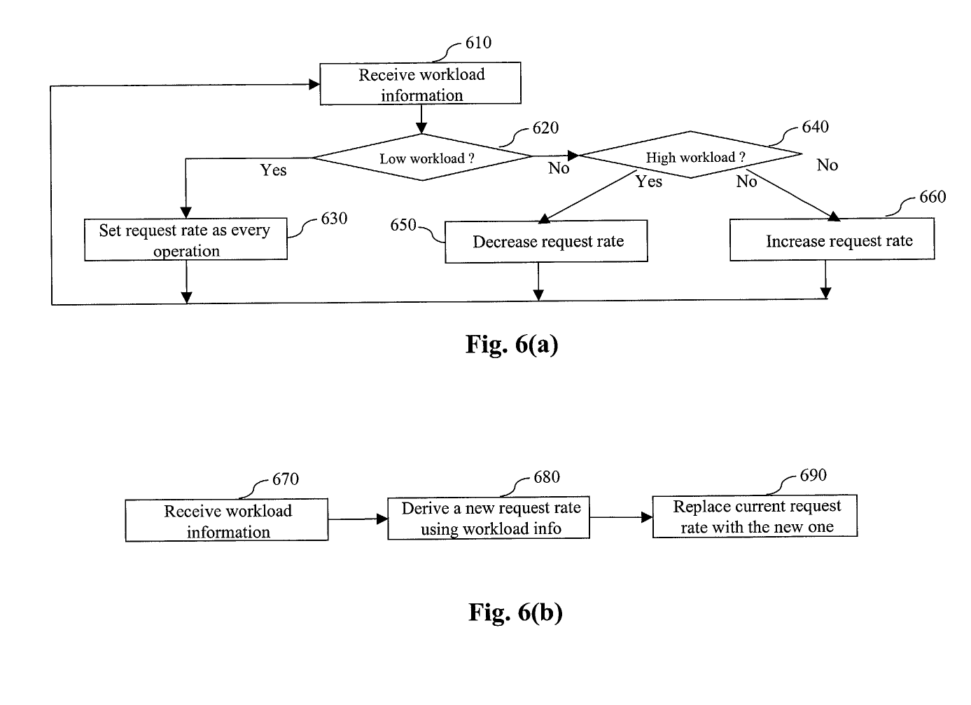

FIGS. 6(a) and (b) are flowcharts of different exemplary processes, in which the completion indication request rate determiner 350 adaptively updates a completion indication request rate based on dynamic workload information, according to different embodiments of the present invention. The completion indication request rate determiner 350 uses workload information to adaptively adjust current completion indication request rate. This may be achieved via different means. For example, it may change the value of the current request rate according to some predetermined criteria based on given workload. Alternatively, it may also simply derive a new request rate and use the newly derived request rate to replace the current request rate.

FIG. 6(a) is a flowchart of an exemplary process, in which the completion indication request rate determiner 350 changes the current completion indication request rate according to some pre-determined criteria based on given workload. Workload information is first received at 610. The received workload information may be supplied from different sources such as the workload determiner 340 or previous completion indications received from the controller 110. The completion indication request rate determiner 350 then determines whether, given the dynamic workload, the current completion indication request rate needs to be revised. Such a decision may be made with respect to some pre-determined criteria. For example, when workload is low, completion indication may be requested for every operation performed. In this case, a threshold may be employed to specify what constitutes a low workload. Alternatively, when workload is high, the completion indication request rate may be decreased to reduce the overhead. A pre-determined workload threshold may be adopted, in this case, to define what constitutes a high workload.

According to the embodiment illustrated in FIG. 6(a), when it is at low workload level, determined at 620, the completion indication request rate is set, at 630, to the rate of transmission request. That is, for every operation requested assigned to the controller 110, a return completion indication is to be returned. If the workload is high, determined at 640, the current request rate is decreased at 650. If the workload is in between low and high levels, the request rate is increased at 660. This updating process continuously utilizes dynamic workload information.

A different exemplary means to adaptively update the current completion indication request rate is to derive a new request rate (based on given dynamic workload) that is then used to replace the current rate. FIG. 6(b) is a flowchart of an exemplary process, in which the completion indication request rate determiner 350 replaces an existing request rate using a new requested rate, derived on-the-fly based on given workload. Workload information is first received at 670. A new request rate is then derived, at act 680, based on the received workload information. The newly derived request rate is then used to replace, at 690, the existing request rate.

Different methods may be employed to derive the new request rate. For example, the new request rate may be computed using a known formula. It may also be derived by extracting a request rate from a look up table based on given workload. In this case, the look up table may be encoded a priori and contain cross references providing correspondences between different workloads and request rates.

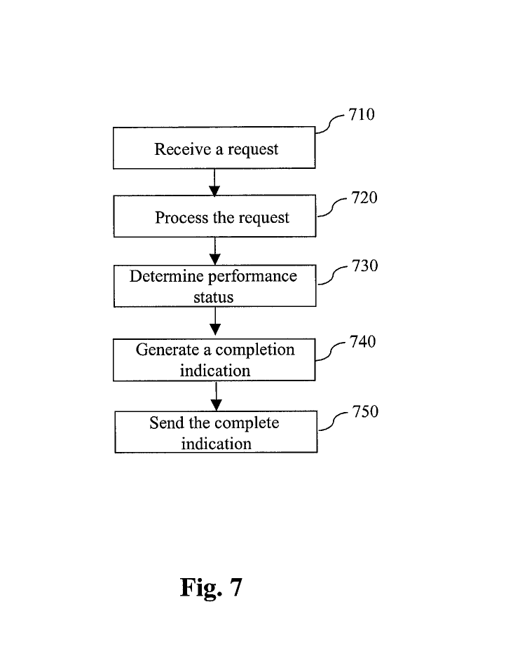

FIG. 7 is a flowchart of an exemplary process, in which the request initiated completion indication mechanism 220 returns a completion indication of an associated task upon receiving a completion indication request, according to an embodiment of the present invention. A completion indication request is first received at 710. The request is then processed at 720. Based on the processing result, the performance status associated with the underlying task is determined at 730. A completion indication is generated, at 740, based on the performance status of the task and is sent, at 750, to the device driver 210.

While the invention has been described with reference to the certain illustrated embodiments, the words that have been used herein are words of description, rather than words of limitation. Changes may be made, within the purview of the appended claims, without departing from the scope and spirit of the invention in its aspects. Although the invention has been described herein with reference to particular structures, acts, and materials, the invention is not to be limited to the particulars disclosed, but rather can be embodied in a wide variety of forms, some of which may be quite different from those of the disclosed embodiments, and extends to all equivalent structures, acts, and, materials, such as are within the scope of the appended claims.

What is claimed is:

1. A method, comprising:
requesting an operation, said requesting informing that new data is ready;
acquiring, after the informing, the new data;
processing the new data after said acquiring;
determining whether a completion indication is requested with respect to the status of the processing; and
sending the completion indication if it is requested.

2. The method according to claim 1, wherein said acquiring the new data includes:
reading a packet descriptor; and
reading a packet associated with the packet descriptor.

3. The method according to claim 2, further comprising:
generating the completion indication prior to said sending based on the status of the transmitting.

4. A method for a workload based completion indication request mechanism, comprising:
determining a dynamic workload;
updating a completion indication request rate based on the dynamic workload; and
sending a completion indication request, according to the completion indication request rate, to request a completion indication.

5. The method according to claim 4, wherein said determining the workload includes determining the workload based on at least some of:
system metric;
device metric; or
bus utilization metric.

6. The method according to claim 5, wherein the completion indication request rate is expressed as at least some of:
a frequency representing the frequency at which a completion indication request is sent;
a periodicity representing the time interval at which a completion indication request is sent; and
an integer representing number of packets between two consecutive completion indication requests.

7. A method for a completion indication request rate determiner, comprising:
receiving information related to workload;
updating current completion indication request rate based on the information related to a workload to generate an updated completion indication request rate.

8. The method according to claim 7, wherein said updating comprises at least one of:
revising the current completion indication request rate according to some some criteria based on the workload; or
replacing the current completion indication request rate using a new completion indication request rate computed based on the workload.

9. The method according to claim 8, wherein said revising the current completion indication request rate comprises:
setting the current completion indication request rate as per operation if the workload is low;
decreasing the current completion indication request rate if the workload is high; and
increasing the current completion indication request rate is the workload is between low and high.

10. A method for a request-initiated completion indication mechanism, comprising:
receiving a request for a completion indication associated with a task;
determining the performance status of the task; and
sending the completion indication according to the performance status of the task.

11. The method according to claim 10, further comprising generating the completion indication prior to said sending based on the performance status of the task.

12. A system, comprising:
a workload based completion indication request mechanism connecting to a device driver for adaptively requesting a completion indication based on a workload; and
a request-initiated completion indication mechanism connecting to a controller that completes tasks assigned by the device driver for sending a completion indication, upon completing a task, if the workload based completion indication request mechanism requests the completion indication.

13. The system according to claim 12, wherein the workload based completion indication request mechanism comprises:
a workload determiner for dynamically determining the workload;
an indication request rate determiner for determining a completion indication request rate based on the workload; and
a completion indication request mechanism for sending a completion indication request to the controller at a rate governed by the completion indication request rate.

14. The system according to claim 13, where the request-initiated completion indication comprises:
a request processing mechanism for processing a completion indication request sent to the controller to request a completion indication associated with a task that the device driver assigns to the controller to perform;
a completion indication generation mechanism for generating the requested completion indication based on the performance status associated with the task; and
a completion indication dispatch mechanism for sending the requested completion indication to the device driver.

15. A workload based completion indication request mechanism connecting to a device driver, comprising:
a workload determiner for dynamically determining a workload;
an indication request rate determiner for determining a completion indication request rate based on the workload; and
a completion indication request mechanism for sending a completion indication request to a controller according to the completion indication request rate.

16. The system according to claim 15, wherein the workload determiner determines the workload of at least one of
the device driver;
a controller that performs tasks assigned by the device driver; and
a bus connecting the device driver and the controller.

17. A request-initiated completion indication mechanism connecting to a controller, comprising:
a completion indication generation mechanism for generating a completion indication requested via a completion indication request based on the status of a task performed by the controller; and
a completion indication dispatch mechanism for sending the completion indication to a device driver that requests the completion indication.

18. The system according to claim 17, further comprising a request processing mechanism for processing the completion indication request sent from a workload based completion indication request mechanism, connected to the device driver, to the controller to request the completion indication associated with the task that the device driver assigns to the controller to perform.

19. A machine-accessible medium encoded with data, the data, when accessed, causing:
requesting a transmission, said requesting informing that new data is ready;
reading, after the informing, the new data;
transmitting the new data after said reading;
determining whether a completion indication is requested with respect to the status of the transmitting; and
sending the completion indication if it is requested.

20. The medium acording to claim 19, the data, when accessed, further causing:
generating the completion indication prior to said sending based on the status of the transmitting.

21. A machine-accessible medium encoded with data for a workload based completion indication request mechanism, the data, when accessed, causing:
determining a dynamic workload;
updating a completion indication request rate based on the dynamic workload; and
sending a completion indication request, according to the completion indication request rate, to request a completion indication.

22. The medium according to claim 21, wherein said determining the workload includes determining the workload based on at least some of:
number of transactions per unit time on a bus;
a utilization percentage of the bus;
number of packets transmitted per unit time; or
number of bytes transmitted per unit time.

23. The medium according to claim 22, wherein the completion indication request rate is expressed as at least one of:
a frequency representing the frequency at which a completion indication request is sent;
a periodicity representing the time interval at which a completion indication request is sent; and
an integer representing number of packets between two consecutive completion indication requests.

24. A machine-accessible medium encoded with data for a completion indication request rate determiner, the data, when accessed, causing:
receiving information related to workload;
updating current completion indication request rate based on the information related to a workload to generate an updated completion indication request rate.

25. The medium according to claim 24, wherein said updating comprises at least one of:
revising the current completion indication request rate according to some some criteria based on the workload; or
replacing the current completion indication request rate using a new completion indication request rate computed based on the workload.

26. The medium according to claim 25, wherein said revising the current completion indication request rate comprises:
setting the current completion indication request rate as per operation if the workload is low;
decreasing the current completion indication request rate if the workload is high; and
increasing the current completion indication request rate is the workload is between low and high.

27. A machine-accessible medium encoded with data for a request-initiated completion indication mechanism, the data, when accessed, causing:
receiving a request for a completion indication associated with a task;
determining the performance status of the task; and
sending the completion indication according to the performance status of the task.

28. The medium according to claim 27, the data, when accessed, further causing generating the completion indication prior to said sending based on the performance status of the task.
